(19) United States
(12) Patent Application Publication
(10) Pub. No.: US 2009/0327623 A1
(43) Pub. Date: Dec. 31, 2009

(54) COMMAND REORDERABLE MEMORY CONTROLLER

(75) Inventor: Wataru Ochiai, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/495,052

(22) Filed: Jun. 30, 2009

(30) Foreign Application Priority Data
Jun. 30, 2008 (JP) 2008-171732

(51) Int. Cl. G06F 12/00

(52) U.S. Cl. 711/154; 711/E12.001

(57) ABSTRACT

A memory controller includes a plurality of bus interfaces and a memory controller core configured to control a command and data issued from the plurality of bus interfaces and to write or read the command and the data into and from the memory. The memory controller core includes a command control unit configured to receive a plurality of commands issued from the plurality of bus interfaces and to reorder and store the plurality of commands and a write data control unit configured to receive a plurality of pieces of write data issued from the plurality of bus interfaces in a sequence that the command control unit receives the write commands and to output the write data based on the reordered result of the command control unit. Accordingly, latency can be minimized between the memory controller and the memory and downsizing of a circuit of the memory controller can be achieved.

### BACKGROUND OF THE INVENTION

1. Field of the Invention

The present invention relates to a memory controller which can reorder a command.

2. Description of the Related Art

Conventionally, a memory controller which reorders and issues a command in a command queue within the memory controller is discussed, for example, in Japanese Patent Laid-open Publication No. 2007-26365.

FIG. 3 illustrates a configuration of the conventional memory controller. A memory controller 000 includes a memory controller core 100 and a plurality of bus interfaces A310, B320, and C330 and controls a memory 200.

The memory controller core 100 includes a command control unit 110, a write data control unit 120, a memory command control unit 130, and an internal bus 140.

In the command control unit 110, a command queue 111 stores commands received from the plurality of bus interfaces A310, B320, and C330. A reordering circuit 112 reorders the commands in the command queue 111.

When the command queue 111 issues a write command to the memory 200, the write data control unit 120 reads out write data from a write data queue of the bus interface which is a master of the command, and temporarily stores the write data in a write data buffer 121 to write the write data into the memory 200.

The memory command control unit 130 performs receiving and sending data among the command control unit 110, the write data control unit 120, and the memory 200.

The internal bus 140 performs receiving and sending commands and data among the command control unit 110, the write data control unit 120, and the plurality of bus interfaces A310, B320, and C330.

In the bus interfaces A310, B320, and C330, command buffers 311, 321, and 331 temporarily store a write request or a read request from a bus outside the memory controller 000. Each of the write data queues 312, 322, and 332 stores data to be written, when each write data queue receives the write request from the bus outside the memory controller 000.

FIGS. 4A and 4B illustrate operations of a conventional memory controller. Each of the steps S101 through S109 illustrates a state of each operation.

Each of the bus interfaces A310, B320, and C330 receives a write request or a read request via the corresponding bus connected thereto. It is assumed that the bus interface A310 received a write request, the bus interface B320 received a read request, and the bus interface C330 received a write request. In this circumstance, the command buffer 311 stores a write command, the command buffer 321 stores a read command, and the command buffer 331 stores a write command. In step S101, the write data queues 312 and 332 of the bus interfaces A310 and C330 which have received the write requests, receive write data to be written into the memory 200, respectively.

In step S102, the bus interfaces A310, B320, and C330 send commands stored in the respective command buffers 311, 321, and 331 to the command queue 111 of the command control unit 110 via the internal bus 140 of the memory controller core 100.

In step S103, the command control unit 110 sorts the commands in the command queue 111 by the reordering circuit 112. In step S104, the command control unit 110 sends a command cmd_{—}02 at the head of the command queue 111 to the memory command control unit 130. Since the command cmd_{—}02 is a read command, the memory controller core 100 sends read data that the memory command control unit 130 read out from the memory 200, to the bus interface B320 which is a source that issued the command cmd_{—}02.

In step S105, the command control unit 110 sends a command cmd_{—}01 at the head of the command queue 111 to the memory command control unit 130. In step S106, since the command cmd_{—}01 is a write command, the memory command control unit 130 makes a request to the write data control unit 120 for write data. In step S107, when the write data control unit 120 receives the request for write data from the memory command control unit 130, the write data control unit 120 makes a request to the bus interface A310 which is a source that issued the write command for the write data.

Upon receiving the request for the write data from the write data control unit 120, the bus interface A310 sends the write data of the write command to the write data control unit 120 from a write data queue 312. In step S108, the write data control unit 120 temporarily stores the received write data in the write data buffer 121. In step S109, the memory controller core 100 sends the write data stored in the write data buffer 121 to the memory command control unit 130. According to the operations as described above, the write data is written into the memory 200.

However, in the above described conventional technique, the write data is read out from the write data queue of the bus interface only after an order of the commands is determined by reordering, when the memory controller writes the data into the memory. In this regard, there is a problem that latency becomes larger between the memory controller and the memory. Further, since each of the plurality of bus interfaces includes a write data queue, there is a problem that the circuit becomes larger in size.

### SUMMARY OF THE INVENTION

The present invention is directed to a memory controller of which latency is small between the memory controller and a memory and of which circuit is small in size.

According to an aspect of the present invention, a memory controller includes a plurality of bus interfaces and a memory controller core configured to control a command and data issued from the plurality of bus interfaces and to write and read the command and data into and from a memory. The memory controller core includes a command control unit configured to receive a plurality of commands issued from the plurality of bus interfaces and to reorder and store the plurality of commands and a write data control unit configured to receive a plurality of pieces of write data issued from the plurality of bus interfaces in a sequence that the command control unit received write commands and to output the write data based on a reordered result of the command control unit.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates an example of a configuration of a memory controller according to an exemplary embodiment of the present invention.

FIGS. 2A and 2B illustrate operations of the memory controller according to the exemplary embodiment of the present invention.

FIG. 3 illustrates an example of a configuration of a conventional memory controller.

FIGS. 4A and 4B illustrate operations of the conventional memory controller.

### DETAILED DESCRIPTION OF THE EMBODIMENTS

Various exemplary embodiments, features, and aspects of the invention will be described in detail below with reference to the drawings.

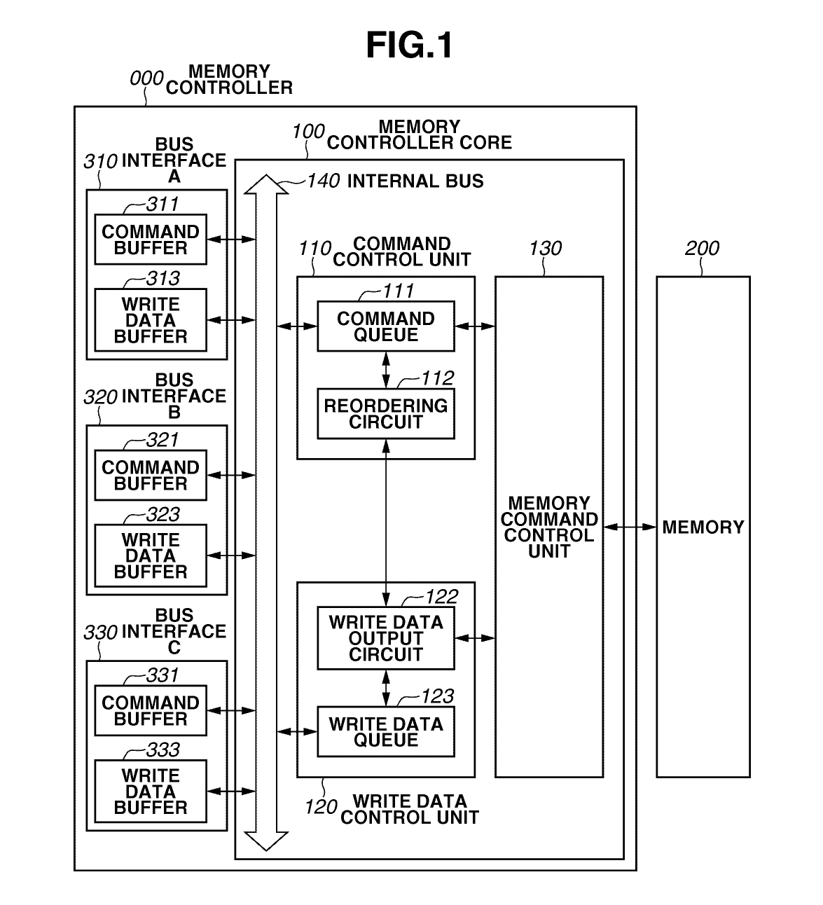

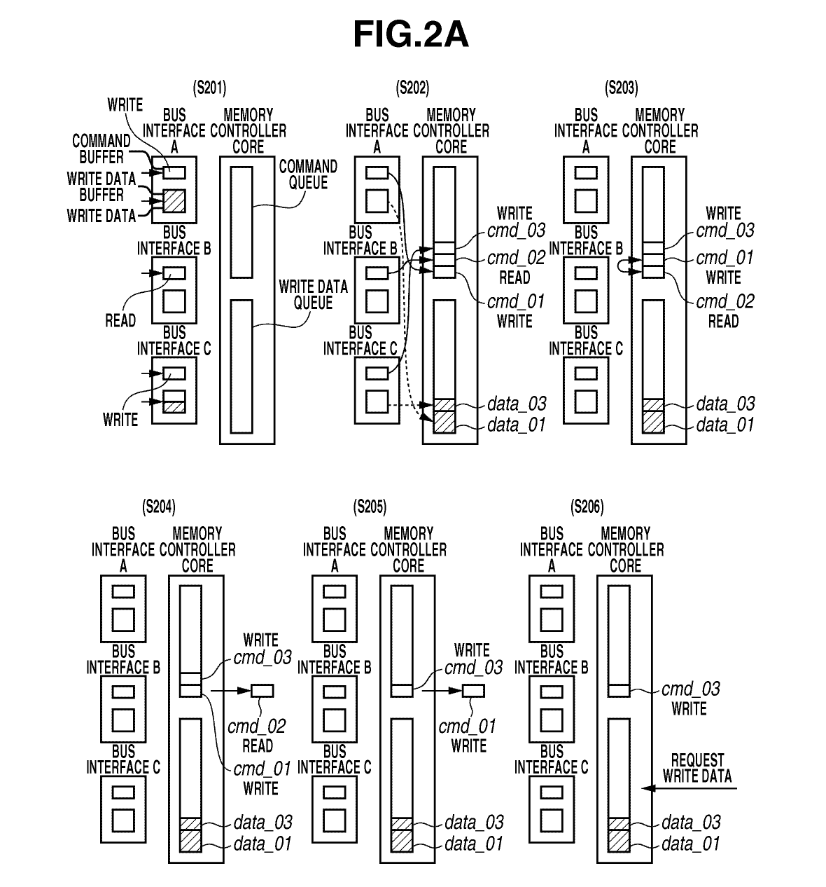

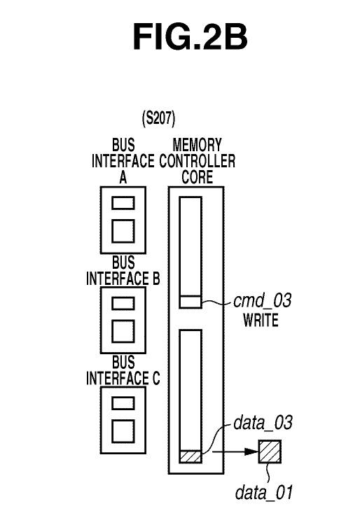

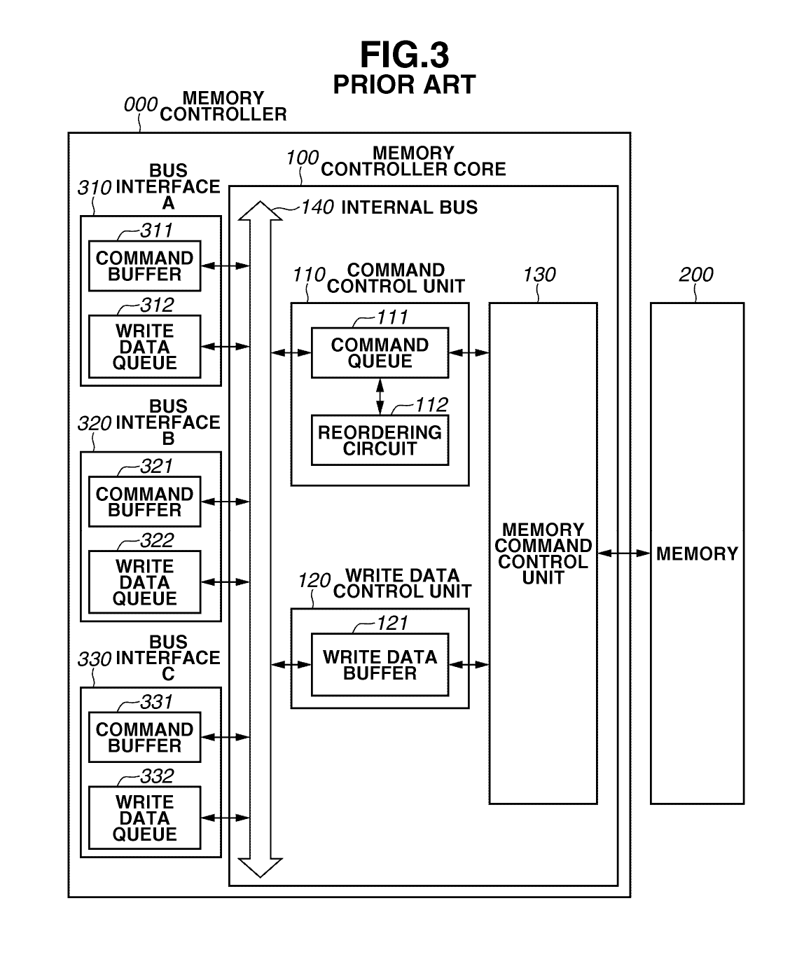

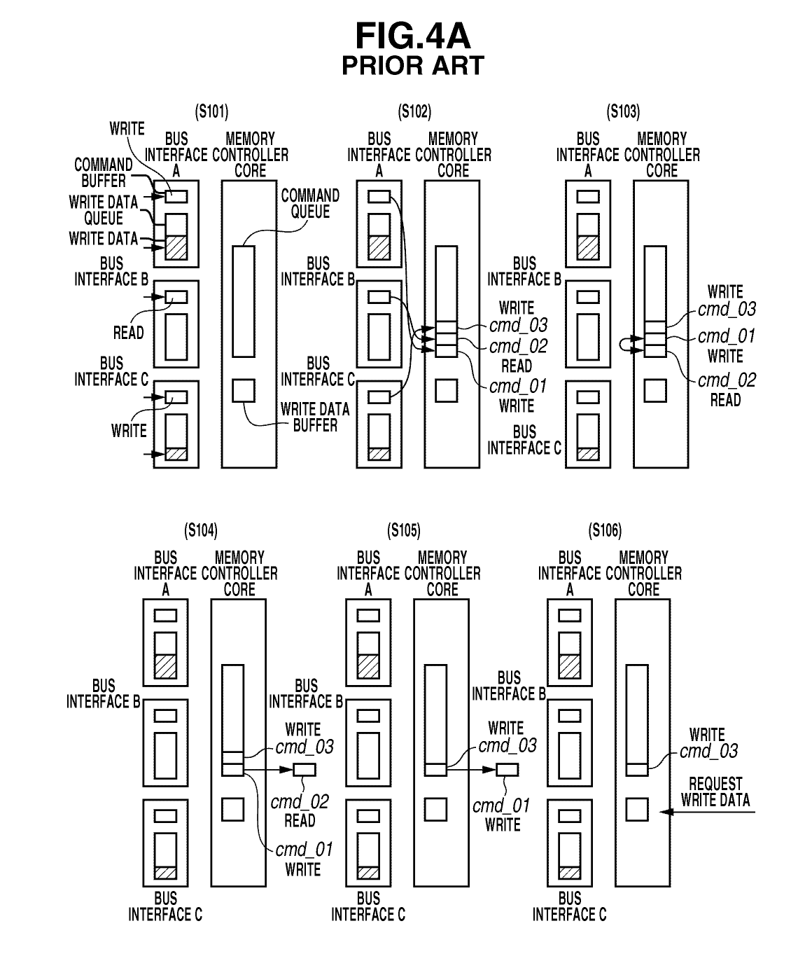

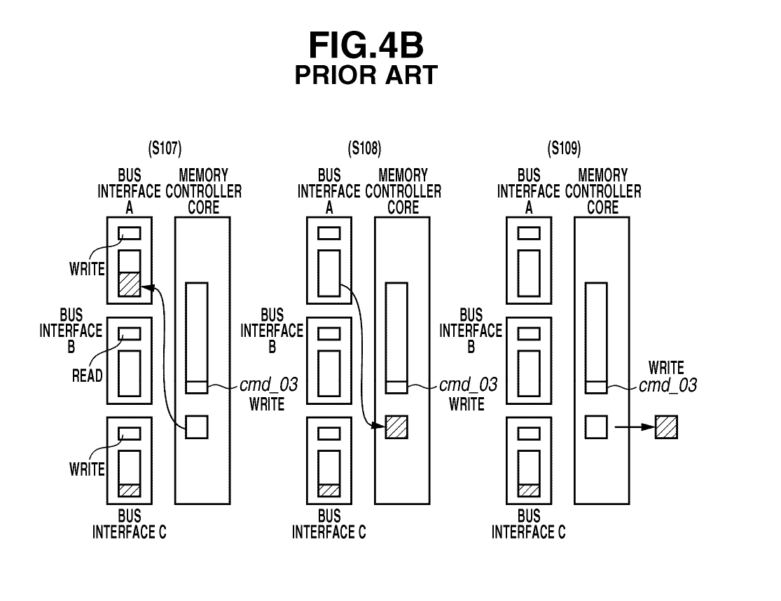

FIG. 1 illustrates an example of a configuration of a memory controller according to an exemplary embodiment of the present invention. A memory controller 000 includes, as similar to the conventional memory controller 000 described with reference to FIG. 3, a memory controller core 100 and a plurality of bus interfaces A310, B320, and C330, in order to control a memory 200. A command control unit 110, a memory command control unit 130, and an internal bus 140 also have the similar configurations to they are described above with reference to FIG. 2. Descriptions of components similar to the components as illustrated in FIG. 3 will be simplified below.

The write data control unit 120 reads out, when a command queue 111 issues a write command to the memory 200, write data from a write data buffer of the bus interface which is a master of the command and writes the write data into the memory 200. In the write data control unit 120, a write data output circuit 122 reads out the write data from a write data queue 123 according to the commands reordered by the reordering circuit 112 and sends the write data to the memory command control unit 130. The write data queue 123 receives the write data, when the plurality of bus interfaces issue write commands, and stores the write data.

In the bus interfaces A310, B320, and C330, the command buffers 311, 321, and 331 have the similar configurations to those described with reference to FIG. 3. Write data buffers 313, 323, and 333 temporarily stores write data when the write data buffers 313, 323, and 333 receive write requests from a bus outside the memory controller 000.

FIGS. 2A and 2B illustrate operations of the memory controller according to the exemplary embodiment of the present invention. Each of the steps S201 through S207 illustrates a state of each operation.

Each of the bus interfaces A310, B320, and C330 receives a write request or a read request via the bus connected thereto. It is assumed that the bus interface A310 received a write request, the bus interface B320 received a read request, and the bus interface C330 received a write request. At the time, the command buffer 311 stores a write command, the command buffer 321 stores a read command, and the command buffer 331 stores a write command. In step S201, the write data buffers 313 and 333 of the bus interfaces A310 and C330 which have received the write requests receive write data to be written into the memory 200, respectively.

Each of the bus interfaces A310, B320, and C330 sends the command stored within the respective command buffers 311, 321, and 331 to the command queue 111 of the command control unit 110 via the internal bus 140 of the memory controller core 100.

In step S202, the bus interfaces A310 and C330 send the write commands as well as send the write data of the write data buffers 313 and 333 to the write data control unit 120. The write data control unit 120 stores pieces of the received write data data_{—}01 and data_{—}03 in the write data queue 123.

In step S203, the command control unit 110 sorts the commands in the command queue 111 by using the reordering circuit 112. In step S204, the command control unit 110 sends a command cmd_{—}02 at the head of the command queue 111 to the memory command control unit 130. Since the command cmd_{—}02 is a read command, the memory controller core 100 sends read data that the memory command control unit 130 read out from the memory 200 to the bus interface B320 which is the source that issued the command cmd_{—}02.

In step S205, the command control unit 110 sends a command cmd_{—}01 at the head of the command queue 111 to the memory command control unit 130. In step S206, since the command cmd_{—}01 is a write command, the memory command control unit 130 requests the write data control unit 120 to send the write data. In step S207, upon receiving the request for the write data from the memory command control unit 130, in the write data control unit 120, the write data output circuit 122 reads out write data data_{—}01 corresponding to the command cmd_{—}01 from the write data queue 123 based on the reordered result, and sends the write data data_{—}01 to the memory command control unit 130.

According to the operations as described above, the write data is written into the memory 200. In the present exemplary embodiment, since there is write data prepared in the write data queue 123 in the write data control unit 120 when the write data is requested from the memory command control unit 130 to the write data control unit 120, the latency can be minimized between the memory controller and the memory. Further, since a write data queue is not provided to each of the plurality of bus interfaces but the write data queue 123 is shared by the plurality of bus interfaces, downsizing of the circuit of the memory controller can be achieved.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2008-171732 filed on Jun. 30, 2008, which is hereby incorporated by reference herein in its entirety.

What is claimed is:

1. A memory controller comprising:
a plurality of bus interfaces; and
a memory controller core configured to control a command and data issued from the plurality of bus interfaces and to write and read the command and data into and from a memory,
wherein the memory controller core comprises:
a command control unit configured to receive a plurality of commands issued from the plurality of bus interfaces and to reorder and store the plurality of commands; and
a write data control unit configured to receive a plurality of pieces of write data issued from the plurality of bus interfaces in a sequence that the command control unit received write commands and to output the write data based on a reordered result of the command control unit.

2. The memory controller according to claim 1, wherein the command control unit includes a command queue configured to store the commands and a reordering unit configured to reorder the commands stored in the command queue.

3. The memory controller according to claim 1, wherein the write data control unit includes a write data queue configured to store the write data and an output control unit configured to output the write data stored in the write data queue in an order of the reordered result by the command control unit.

4. The memory controller according to claim 3, further comprising:
a memory command control unit configured to issue a write data request to the write data control unit in response to the write command output from the command control unit;
wherein the write data control unit outputs write data corresponding to the write command relating to the write data request from the write data queue in response to the write data request.
